(19) United States
(12) Patent Application Publication
(10) Pub. No.: US 2015/0254201 A1
(43) Pub. Date: Sep. 10, 2015

(54) STANDARD PCI EXPRESS ADD-IN CARD FORM FACTOR MULTI PORTS NETWORK INTERFACE CONTROLLER SUPPORTING MULTI DIMENSIONAL NETWORK TOPOLOGIES

(71) Applicant: EMILIO BILLI, San Jose, CA (US)

(72) Inventor: EMILIO BILLI, San Jose, CA (US)

(21) Appl. No.: 14/201,654

(22) Filed: Mar. 7, 2014

(51) Int. Cl. G06F 13/40

(52) U.S. Cl. CPC G06F 13/4022

(57) ABSTRACT

A PCI Express Add-in Card form factor PCI Express to RapidIO multiport network adapter card, that can be internally hosted by standard servers and workstations, comprising at least a PCIe to RapidIO bridge and at least one RapidIO capable switch, with at least six external connectors, or more, that allows for the connection of multiple servers together and/or RapidIO end points using copper or optical cables, that provides the ability to implement a high density embedded RapidIO switch functionality, with all the features present in standard 19″ rack mount switches or in complex backplanes, inside the card, without using additional external networking hardware.

### BACKGROUND OF THE INVENTION

1. Field of Invention

The present invention refers to a PCI Express, Peripheral Component Interconnect Express (PCIe), Add-in Card form factor PCIe to RapidIO multiport NIC (network interface controller) card assembly. Standard personal computers, servers and workstations, equipped with at least one PCIe capable slot, can internally host that card. The card has up to six board-mount cable connectors, or more, that allow the creation of switchless multidimensional clusters and datacenter networks. The solution enables all the features supported by the RapidIO networking standard without external networking equipment. The card supports high availability, low latency point-to-point communications, message passing and shared memory architecture with or without IO sharing. This NIC enables the use of RapidIO as interconnection network in PCIe capable servers and clusters and more in general in X86 based servers provided by a PCIe slot. The card eliminates the necessity of additional external hardware, like external switches, optimizing the space and the cabling among the servers, reducing the power consumption, simplify the scalability and realizing a real energy proportional network high scalable interconnect by using copper or optical links.

2. Description of Related Art

Traditional interconnection networks, used in datacenters, comprise at least one switch and a series of server NICs (network interface controllers) connected to this switch. Multiple switches are used together in order to create complex interconnection network topologies like a fat tree topology.

This standard solution presents many drawbacks that can be resumed in: high complexity of deploying, large amount of cables, large number of switches with very high power consumption and total cost of ownership.

This solution consists in the creation of an interconnection network card in a PCIe standard form factor that provides all the functionalities needed to create a fully working interconnection network without using additional hardware and external switches by integrating in the same network adapter the NIC and the network switch. The resulting NIC card is able to provide multiple interconnection ports that can be used to realize point-to-point server-to-server connections enabling the use of different interconnection topologies like 1D torus, 2D torus, 3D torus, Hypercubes and other multidimensional topologies. This solution enables an enormous integration in terms of I/O density in modern server eliminating the needs of external switch equipment that needs additional space, and adds more flexibility when the number of servers needs to scale.

The support of multidimensional networks permits also a great optimization of the number of the cables needed to create the links between large number of servers in a datacenter or in a clustered environment. For example in a 64 nodes cluster a standard fat tree network uses 384 cables compared to only 192 cables in 2D torus for connect the same number of nodes resulting in a less complex network deploying and lower costs.

There is a need in the art for a new generation of interconnection network that enables energy proportional scalability inside a cluster and datacenter and simplifies the insertion of new servers to existing infrastructure without adding expensive and power hungry additional equipment like switches.

There is also the need to implement different kind of topologies inside the datacenter in order to optimize both efficiency and scalability of new generation of applications realizing a low latency flexible interconnection network.

There is also the need in the art for a complete PCIe based NIC card that can be fitted inside any kind of server, equipped with at least one PCIe slot, that provides networking capability by using multiple board-mount external network ports that allows for the connection of multiple servers without using external additional networking hardware, like external additional switches, that reduces the complexity and the power consumption.

### SUMMARY

Embodiments of the invention provide a standard PCIe Add-in Card form factor RapidIO interconnection card with multiple board-mount network ports, starting from four to six or more, used for external server to server connection by copper or optical cables in multiple topologies.

In general, in one aspect, embodiments of the invention relate to a standard PCIe Add-in Card form factor RapidIO network card with inside at least a PCIe to RapidIO bridge and a RapidIO switch. The switch assembly comprises, among other things, at least one port connected to the RapidIO bridge. Switch chip is coupled to up to 6 board-mount cable connectors containing a total of 6 RapidIO ports that can be configured in any combination according with the specific features of the RapidIO switch chip features.

In some embodiments, the PCIe to RapidIO bridge can be integrated into the RapidIO switch realizing a single chip PCIe to multiport RapidIO system on chip.

In general, in another aspect, embodiments of the invention relate to a standard PCIe RapidIO interconnection network card. The network card assembly comprises, among other things, up to six board-mount connectors used for cable connection supporting multidimensional network topologies like 1D, 2D, 3D torus, Hypercubes and other multidimensional topologies like Kautz Graph.

Additional and/or alternative aspects of the invention will become apparent to those having ordinary skill in the art from the accompanying drawings and following detailed description of the disclosed embodiments.

### BRIEF DESCRIPTION OF THE DRAWINGS

The apparatus of the invention is further described and explained in relation to the following figures of the drawing wherein;

FIG. 1 is a top view of the 3D RapidIO network card—realized in a PCIe Low Profile size—with six external network ports.

FIG. 2 is an isometric view of the 3D RapidIO network card—realized in a PCIe Standard height size—with six external network ports.

FIG. 3 represents some interconnection topologies that can be realized with the multiport NIC.

### DETAILED DESCRIPTION OF THE PREFERRED EMBODIMENTS

The figures described above and the written description of specific structures and functions below are not presented to limit the scope of what Applicants have invented or the scope of the appended claims. Rather, the figures and written descriptions are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the invention or the appended claims.

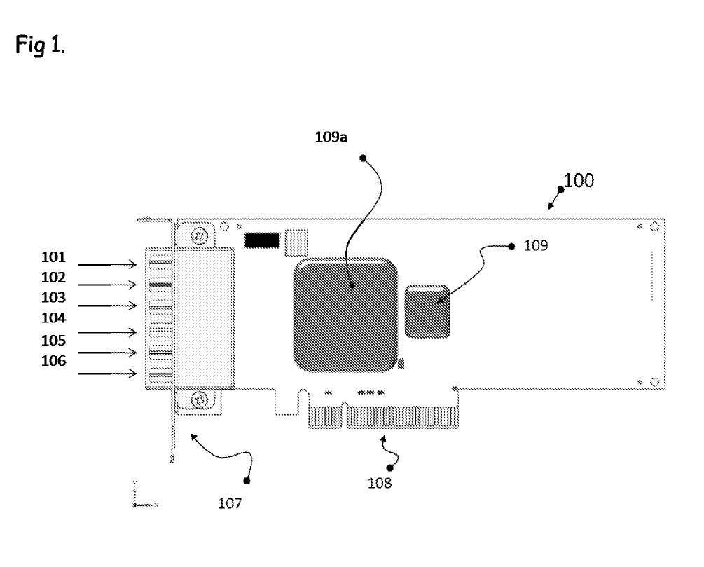

As shown in at least FIG. 1 the PCIe RapidIO network card assembly 100 comprises 6 cable connectors (101, 102, 103, 104, 105, 106 for external connection to other PCIe RapidIO multiport NIC devices or to a RapidIO end point using an opportune adapter), a PCIe bracket (107, permitting the retention of the switch in a standard server slot) and a PCIe PCB 8x connector (108, realized with edge finger pads) used for the connection with the root complex present in the server using an internal PCIe compliant slot. A PCIe to RapidIO bridge switch chip 109 and a full capable RapidIO switch 109a are used to realize the connections among the different PCIe-RapidIO NICs realizing the scope of the invention.

PCIe add-in cards are governed by the industry standards set forth in the PCI Express® Card Electromechanical Specification. In particular the standard sets forth height, length, width, and other form factor parameters in the section titled “Add-in Card Form Factors and Implementation.”

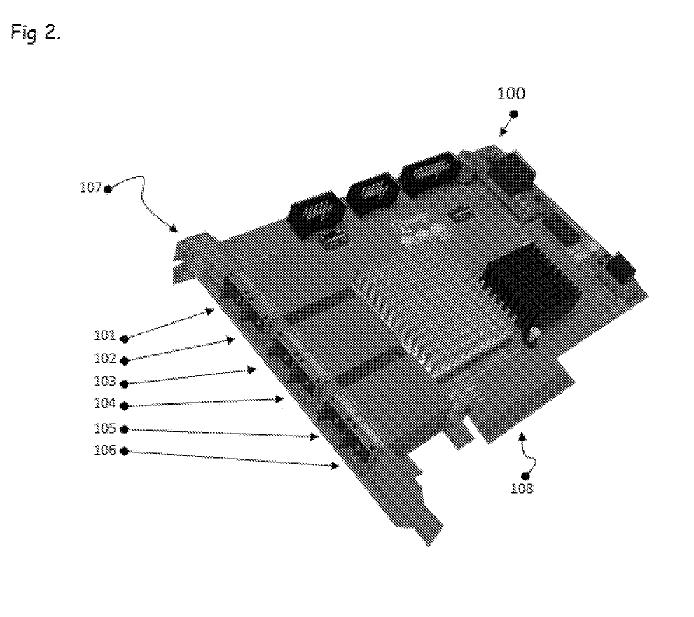

As shown in FIG. 2, the NIC 100 can be realized using a different type of external connectors 101, 102, 103, 104, 105, 106 in order to realize six external links. A PCIe bracket 107 permits the retention of the NIC in a standard server slot and a PCIe PCB 8x connector (realized with edge finger pads) 108 is used for the connection with the root complex present in the server using an internal PCIe compliant slot. The functionalities are the same of the NIC described in FIG. 1.

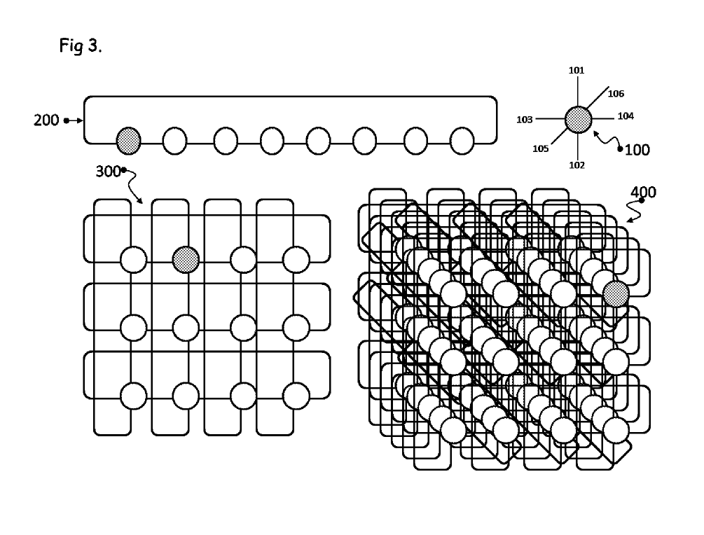

As shown in FIG. 3. different topologies can be realized using the 6 connectors available on the NIC installed in the servers 100 that realize the links 101, 102, 103, 104, 105, 106. Using these links in opportune combinations, already known in the art, is possible to realize, but not limited to: a 1D torus topology 200, a 2D torus topology 300, a 3D torus topology 400.

The present invention is related to PCIe RapidIO NIC assembly 100 that can have up 6, or more, RapidIO 4x ports (but they could also be 1x, 2x, 8x, 16x ports or a mix of them) that can be used to connect multiple external RapidIO end points. A PCIe RapidIO NIC assembly—normally hosted in a 19″ rack mount enclosure in a standard PCIe slot that normally is present in every modern server—with six connectors, or more, allows the implementation of all the features of a standard RapidIO switch based network fabric without a specific backplane implantation or using external RapidIO switches. Other than that, it enables the implementation of multidimensional network topologies without using additional hardware. This allows the scale up of the number of interconnected servers in a cluster or in a datacenter without impact on the rack space available enabling the creation of server clusters with complex topologies that have well-known and documented benefits in terms of high availability and low latency compared with the traditional external switch-based topologies. The present invention allows for transmission of network data over up to of six, or more, independent concurrent channels creating hardware based fault tolerant systems without using additional hardware like redundant external switches.

Stated in other terms, the present invention is related to a standard PCIe Add-in Card form factor RapidIO to PCIe based NIC. This card has embedded at least one PCIe to RapidIO Bridge and at least one RapidIO capable Switch, with at least six external cable connectors, or more, that are used for external card-to-card connectivity or card to other system connectivity. The external connectors provide the ability to implement a high density embedded RapidIO switch functionality, with all the features present in standard 19″ rack mount switches or in complex backplanes inside the card. This card enables the scale up of the number of servers, in a cluster environment, and the creation of complex architectures using all the features provided by RapidIO protocol including the networking capabilities, the shared memory support, the message passing support, the I/O sharing support, without additional external networking hardware. A cluster network is a type of network system comprising multiple computer systems that are connected to one another in a specific topology. Each computer system serves as a node in the topology. The present invention provides a NIC assembly that is capable of fitting six network ports (each with eight differential pairs) within the PCIe standard bracket permitting to create different configurations connecting together multiple servers.

1. A PCI Express add-in card form factor RapidIO PCI Express multiport network controller, with embedded a RapidIO switch and an external multiport interface with multiple RapidIO cable connectors, that can be internally hosted by standard servers and workstations, with at least one PCIe slot, comprising:
at least one board-mount multiport connector, or a plurality of single connectors, for external RapidIO cable connection connected to an internal switch;
at least one PCB based PCIe standard slot compliant with the PCI-SIG specification that can fit in a PCIe slot capable in a server motherboard used to connect the card to the Host processor by a PCI Express interface.
at least a PCIe to RapidIO bridge used to bridge the PCI Express bus to the RapidIO bus
at least a RapidIO multiport switch

2. A PCI Express RapidIO NIC, with embedded a PCIe to RapidIO bridge and at least one multiport RapidIO switch, wherein the multiport cable connectors are used to realize a complete interconnection network among servers, or RapidIO end points, using different topologies comprising but not limited at 1D Torus, 2D torus, 3D torus, Hypercubes without using additional external networking hardware.

3. A PCI Express RapidIO multiport network controller assembly, with embedded switching capabilities, designed to fit in any standard server equipped with at least one PCIe slot interface, wherein the network capabilities and related physical inter server links, can be implemented using copper or optical links or a combination of both at the same time.

4. A PCI Express RapidIO multiport network controller assembly as described in the drawings in FIG. 1 and FIG. 2
